(19) United States
(12) Patent Application Publication
(10) Pub. No.: US 2026/0072179 A1
(43) Pub. Date: Mar. 12, 2026

(54) GLOBAL NAVIGATION SATELLITE SYSTEM (GNSS) REPORTING FOR REDUCED CAPABILITY DEVICES

(71) Applicant: InterDigital Patent Holdings, Inc., Wilmington, DE (US)

(72) Inventors: Dylan Watts, Montreal (CA); Oumer Teyeb, Montreal (CA); Janet Stern-Berkowitz, Little Neck, NY (US); Brian Martin, Farnham (GB)

(73) Assignee: InterDigital Patent Holdings, Inc., Wilmington, DE (US)

(21) Appl. No.: 19/108,381

(22) PCT Filed: Sep. 22, 2023
(86) PCT No.: PCT/US2023/074873

§ 371 Date: Mar. 3, 2025

Related U.S. Application Data
(60) Provisional application No. 63/410,321, filed on Sep. 27, 2022.

(51) Int. Cl. G01S 19/25; H04W 74/0833; H04W 76/10; H04W 76/27

(52) U.S. Cl. CPC G01S 19/25; H04W 74/0833; H04W 76/10; H04W 76/27

(57) ABSTRACT

A wireless transmit receive unit (WTRU) is configured to receive configuration information for reporting Global Navigation Satellite System (GNSS) assistance information (AI). The configuration information comprises a reporting trigger threshold that is at least one of a distance threshold or a time offset threshold. The WTRU determines that the reporting trigger threshold is exceeded and reports GNSS AI. The GNSS AI comprises at least one of a GNSS validity duration or a GNSS acquisition time. The GNSS validity duration comprises an indication of a time duration associated with a validity of a GNSS acquisition, an indication of a time duration associated with expiration of the GNSS acquisition, or a WTRU location associated with the GNSS acquisition. The GNSS acquisition time comprises a time to acquire a GNSS position.

### CROSS REFERENCE TO RELATED APPLICATIONS

This application claims the benefit of U.S. Provisional Application No. 63/410,321 filed Sep. 27, 2022. The entire contents of which are herein incorporated by reference in their entirety.

### BACKGROUND

A Global Navigation Satellite System (GNSS) may include global, regional, and augmentation satellite systems such as GPS, Galileo and GLONASS systems. In certain scenarios, GNSS may be designed to inter-work with a network. If a GNSS is designed to inter-work with a network, the network may assist a WTRU GNSS receiver to improve performance.

### SUMMARY

A wireless transmit receive unit (WTRU) may be configured to receive configuration information for reporting Global Navigation Satellite System (GNSS) assistance information (AI). The configuration information may comprise a reporting trigger threshold that is at least one of a distance threshold or a time offset threshold. The WTRU may determine that the reporting trigger threshold is exceeded. The WTRU may report GNSS AI. The GNSS AI may comprise at least one of a GNSS validity duration or a GNSS acquisition time. The GNSS validity duration may comprise an indication of a time duration associated with a validity of a GNSS acquisition, an indication of a time duration associated with expiration of the GNSS acquisition, or a WTRU location associated with the GNSS acquisition. The GNSS acquisition time may comprise a time to acquire a GNSS position.

The GNSS AI may comprise at least one of a measurement gap configuration or a configuration index.

The WTRU may be further configured to modify the distance threshold or the time offset threshold based on at least one of a speed of the WTRU, a mobility state of the WTRU, or at least one characteristic of a satellite of a non-terrestrial network.

Reporting the GNSS AI may be done using a different type of signaling based on reporting the GNSS validity duration or the GNSS acquisition time.

The reporting trigger threshold may be exceeded when the WTRU is scheduled to transmit or receive a transmission at a time that is less than the time offset threshold from the GNSS validity duration expiry.

The reporting trigger threshold may be exceeded when a current location of the WTRU exceeds the previously reported WTRU location by a configured threshold.

The WTRU may suspend user plane and control plane traffic (e.g., reception and transmission) to receive GNSS information.

The WTRU may be an internet of things (IOTs) device.

The WTRU may be a reduced capability (RedCap) device.

A GNSS AI location report may be sent using a medium access control (MAC) information element (IE).

Reporting the GNSS AI may be included in a measurement report.

Reporting the GNSS AI may be done using WTRU capability signaling.

The WTRU may be further configured to receive the measurement gap configuration based on the reporting trigger threshold being exceeded, wherein the measurement gap configuration is associated with a length of time to suspend WTRU reception and transmission.

The WTRU may be further configured to monitor the reporting trigger threshold to determine if the reporting trigger threshold has been exceeded or not.

The GNSS AI may be reported via a medium access control (MAC) information element (IE) when the GNSS AI comprises the GNSS validity duration, and wherein the GNSS AI is reported via a radio resource control (RRC) based on an RRC state when the GNSS AI comprises the GNSS acquisition time.

A wireless transmit receive unit (WTRU) may receive, via configuration information, at least one prohibition condition configured to prohibit GNSS activity. The GNSS activity may comprise at least one of GNSS acquisition, GNSS reporting, or GNSS assistance information (AI) reporting. The WTRU may identify a trigger related to the GNSS activity. The WTRU may determine whether a prohibition condition is activated. The prohibition condition may comprise a condition based on a prohibition timer, a condition based on GNSS validity duration, or a condition based on a characteristic of the WTRU. When the prohibition condition is determined to be active, the WTRU may perform the GNSS activity in response to an override or termination of the prohibition condition and based on the prohibition condition being determined to be active.

The WTRU may perform the GNSS activity when the prohibition condition is determined to be inactive. The characteristic of the WTRU may comprise at least one of GNSS acquisition AI, a location change, or change in speed of the WTRU.

The WTRU may determine the override or the termination of the prohibition condition in response to: one or more triggering events for GNSS reporting or reporting occurring during a prohibit time period, wherein the prohibit time period exceeds a threshold; reception of an explicit request to override; or an expiration of a GNSS validity timer during the prohibit condition.

The WTRU may monitor for one or more trigger conditions when the prohibition condition is determined to be active. The prohibition condition may be based on one or more of the following: a GNSS validity duration, a WTRU location, or a WTRU speed.

The WTRU may, in the performance of the GNSS activity, report via a medium access control (MAC) information element (IE) when GNSS AI comprises GNSS validity duration, and report via a radio resource control (RRC), based on an RRC state, when the GNSS AI comprises a position fix duration.

The WTRU may, when GNSS reporting conditions are satisfied and the prohibit condition is active, do one or more of the following: delay GNSS activity until the prohibit condition is not active or expired, indicate that the prohibit condition is active, or indicate when GNSS activity is to be enabled.

The WTRU may stop transmitting and receiving data signals, control signals, and reference signals (e.g., SSB, PRS, CSI-RS) to receive GNSS information. The WTRU may be an internet of things (IOTs) device. The WTRU may be a reduced capability (RedCap) device.

A wireless transmit receive unit (WTRU) may be configured to perform global navigation satellite system assistance information (GNSS AI) reporting. The WTRU may receive a GNSS configuration. The GNSS configuration may comprise one or more triggering conditions associated with GNSS AI reporting. The GNSS configurations may further comprise biasing conditions associated with each of the one or more triggering conditions. The WTRU may apply a bias to each of the one or more triggering conditions. For example, the bias may be applied based on one or more of a: a speed associated with the WTRU, a mobility state estimation, and/or a characteristic associated with a satellite. The WTRU may detect a triggering condition of the one or more triggering conditions. The WTRU may send a GNSS AI report based on the detection of the triggering condition. For example, the GNSS AI report may be sent using a medium access control (MAC) information element. For example, the GNSS AI report may be included in a measurement report. For example, the GNSS AI report may be sent using WTRU capability signaling.

### BRIEF DESCRIPTION OF THE DRAWINGS

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment.

FIG. 2 illustrates an example associated with a non-terrestrial network (NTN);

FIG. 3 illustrates an example associated with a protocol stack;

FIGS. 4A and 4B illustrate examples associated with GNSS acquisition;

FIG. 5 illustrates an example associated with a measurement gap configuration;

FIG. 6 illustrates an example associated with a reporting procedure;

FIG. 7 illustrates an example associated with GNSS reporting; and

FIG. 8 illustrates another example associated with a reporting procedure.

### DETAILED DESCRIPTION

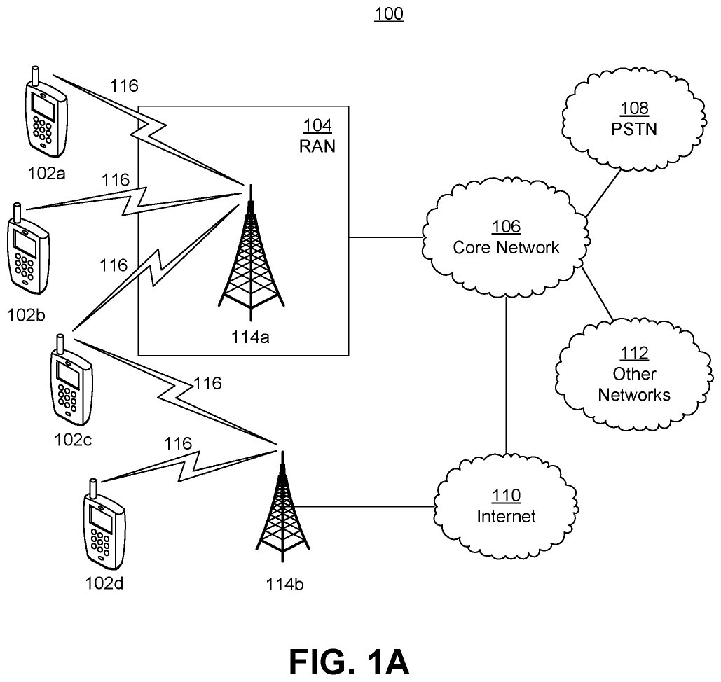

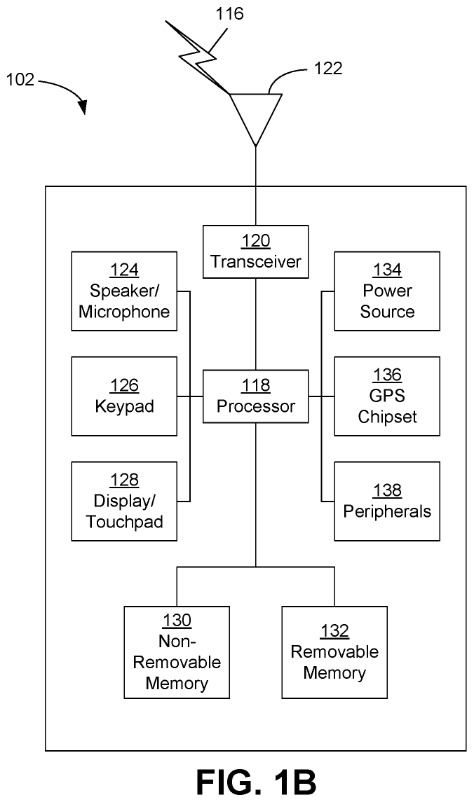

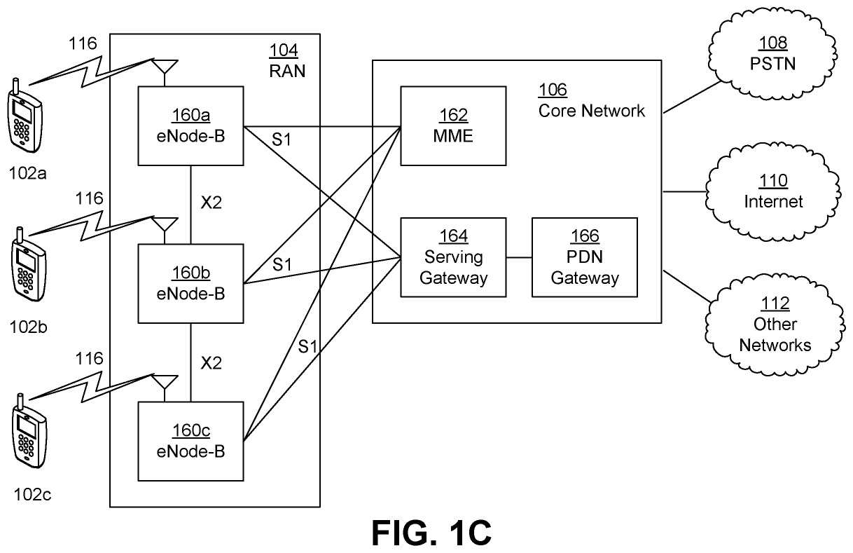

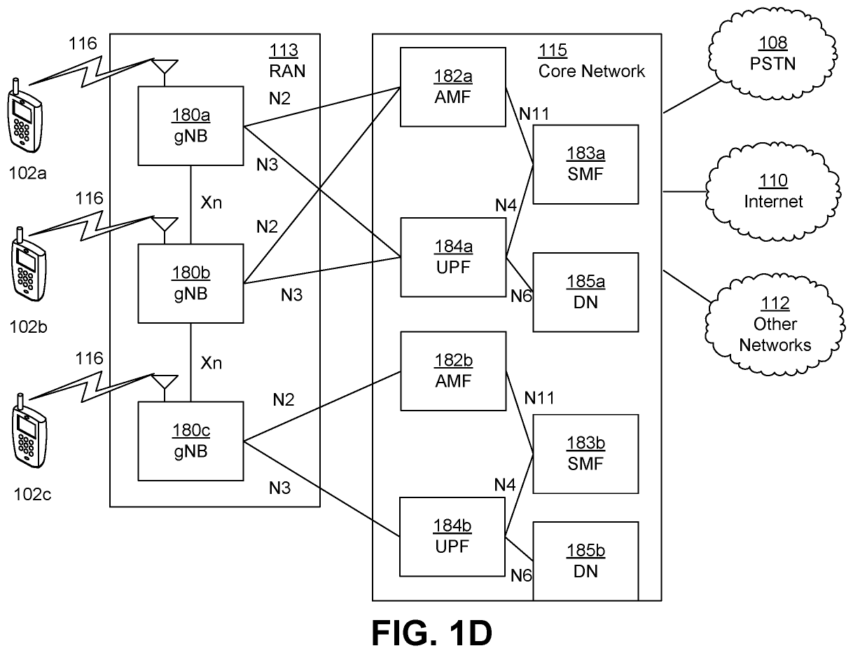

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (WTRU), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b. 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

As described herein, Global Navigation Satellite System (GNSS) may include global, regional, and augmentation satellite systems such as GPS, Galileo and GLONASS systems. In certain scenarios, GNSS may be designed to inter-work with a network (e.g., NG-RAN). If a GNSS is designed to inter-work with a network, the network may assist a WTRU GNSS receiver to improve performance (e.g., to limit search window and increase sensitivity). The assistance data signaling from the network to the WTRU may include one or more of the following: data to assist in measurements, data that may be used for position calculations, data that may be used to increase the positioning accuracy, and/or data that may facilitate the integrity results determination of the calculated location.

One or more GNSS modes may be supported. For example, WTRU-Assisted GNSS and/or WTRU-Based GNSS may be supported. In WTRU-Assisted GNSS, for example, a WTRU may perform GNSS measurements (e.g., pseudo-ranges, pseudo Doppler, carrier phase ranges, etc.). The WTRU may send the GNSS measurements to the network (e.g., a network function, such as the LMF). A position calculation may be performed based on the GNSS measurements and/or additional measurements from other (e.g., non GNSS) sources. In WTRU-Based GNSS, for example, a WTRU may perform GNSS measurements. The WTRU may calculate its own location based on the GNSS measurements, additional measurements from other (e.g., non GNSS) sources, and/or assistance data from the network (e.g., a network function, such as LMF).

Information may be sent to the network (e.g., a network function, such as LMF), based on the relevant GNSS mode (e.g., WTRU-Assisted and/or WTRU-Based). For example, Table 1 provides examples of the information that may be transferred from the WTRU to the network.

TABLE 1

| | | WTRU- |
|---|---|---|
| | WTRU- | based/ |
| Information | assisted | standalone |
| Latitude/Longitude/Altitude, together with | No | Yes |
| uncertainty shape | | |
| Velocity, together with uncertainty shape | No | Yes |
| Reference Time, possibly together with GNSS | Yes | Yes |
| to NG-RAN time association and uncertainty | | |
| Indication of used positioning methods in the fix | No | Yes |
| Code phase measurements, also called pseudo-range | Yes | No |
| Doppler measurements | Yes | No |
| Carrier phase measurements, also called | Yes | No |
| Accumulated Delta Range (ADR) | | |
| Carrier-to-noise ratio of the received signal | Yes | No |
| Measurement quality parameters for each | Yes | No |
| measurement | | |
| Additional, non-GNSS related measurement | Yes | No |
| information | | |

Non-terrestrial networks (NTN) may be used to facilitate deployment of certain networks (e.g., wireless networks in areas where land-based antennas are impractical, for example due to geography and/or cost). Terrestrial networks may be coupled with NTN, which may increase network coverage. NTN deployments may support talk, text, and/or enhanced services (e.g., web browsing).

An NTN may include an aerial and/or space-borne platform which, via a gateway (GW), transports signals from a land-based based gNB to a WTRU and vice-versa. A NTN may support power class 3 WTRUs, for example, with omnidirectional antenna and linear polarization and/or a very small aperture antenna (VSAT) terminal with directive antenna and circular polarization. Also, or alternatively, an NTN may support LTE-based narrow-band IoT (NB-IoT) and eMTC type devices.

Aerial and/or space-borne platforms may be classified in terms of orbit. Low-earth orbit (LEO) satellites may include satellites associated with an altitude range of 300-1500 km. Geostationary earth orbit (GEO) satellites may include satellites associated with an altitude range of 35-786 km. Medium-earth orbit (MEO) satellites may include satellites associated with and altitude range of 7000-25000 km. High-altitude platform stations (HAPS) may include stations associated with an altitude of 8-50 km. Satellite platforms may further be classified by payload (e.g., “transparent” and/or “regenerative”). Transparent satellite payloads, for example, may implement frequency conversion and RF amplification in both the uplink and the downlink (e.g., with multiple transparent satellites possibly connected to a land-based gNB). Regenerative satellite payloads, for example, may implement a gNB and/or gNB distributed unit (DU) onboard the satellite. Regenerative payloads may also, or alternatively, perform digital processing on signals including, for example, demodulation, decoding, re-encoding, re-modulation and/or filtering.

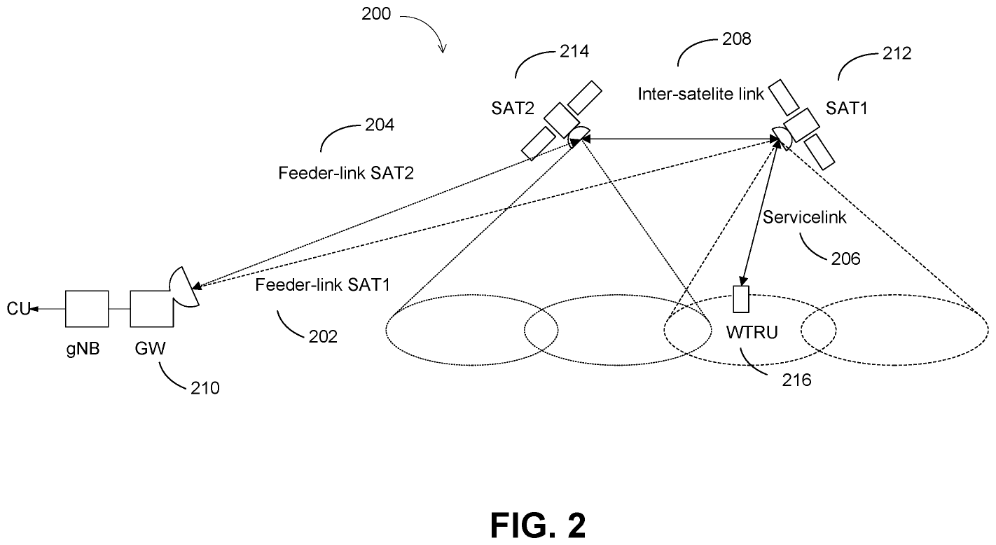

FIG. 2 illustrates an example 200 associated with interfaces in an NTN. One or more radio interfaces may be defined in an NTN, including, for example: a feeder-link 202, 204, a service link 206, and/or an inter-satellite link (ISL) 208. A feeder-link 202, 204, for example, may include a wireless link between a gateway (GW) 210 and one or more respective satellites 212, 214. Service link 206, for example, may include a radio link between the satellite and a WTRU 216. An ISL 208 may include a transport link between satellites. For example, an ISL may be (e.g., may only be) supported by regenerative payloads and/or may be a 3GPP radio and/or proprietary optical interface. Example 200 associated with interfaces in an NTN may also comprise a central unit (CU).

Depending on the satellite payload configuration, different interfaces (e.g., 3GPP interfaces) may be used for a radio link (e.g., each radio link). In a transparent payload, for example, a Uu interface (e.g., an NR-Uu radio interface) may be used for both the service link and feeder-link. Uu may refer to Universal Mobile Telecommunications System (UMTS) Air Interface, which is a radio interface between the UMTS Terrestrial Radio Access Network (UTRAN) and the WTRU 216 utilizing code-division multiple access (CDMA). For a regenerative payload, for example, a Uu interface (e.g., an NR-Uu radio interface) may be used on the service link, and a satellite radio interface (SRI) may be used for the feeder-link.

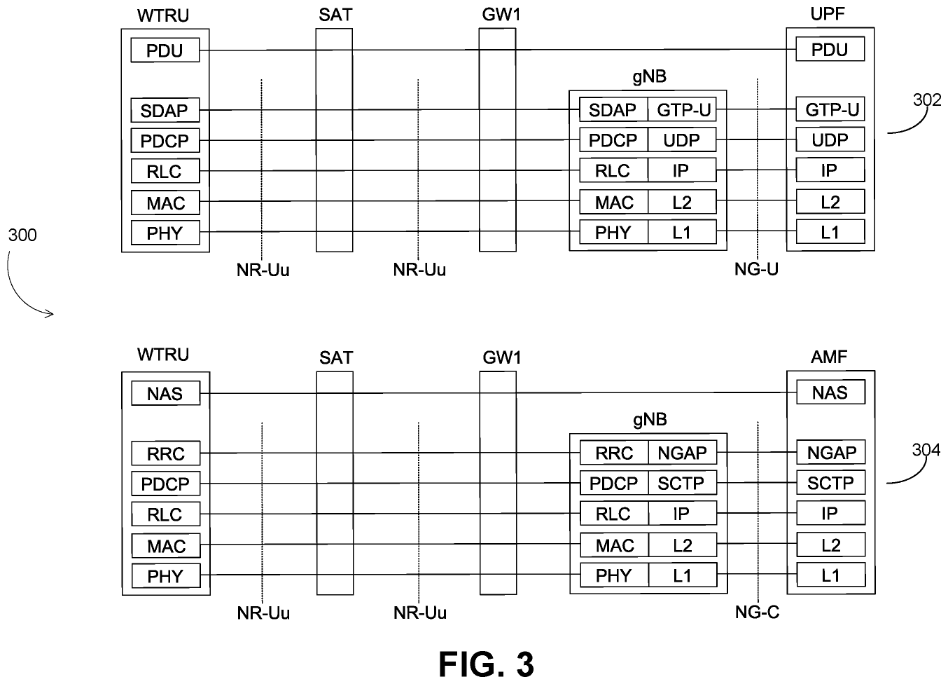

FIG. 3 illustrates an example user plane (UP) 302 and control plane (CP) 304 protocol stack 300 for a transparent satellite configuration.

An NTN satellite may support one or more cells. A cell may include one or more satellite beams. Satellite beams may cover a footprint on earth (e.g., like a terrestrial cell), which may range in diameter. For example, beams in low earth orbit (LEO) deployments may range from 100-1000 km in. Beams in geostationary earth orbit (GEO) deployments may range from 200-3500 km. Beam footprints in GEO deployments may be fixed, for example, relative to earth. In LEO deployments, for example, the area covered by a beam/cell may change over time, e.g., due to satellite movement. Beam movement in LEO deployments may be classified as “earth moving.” For example, the LEO beam may move continuously across the earth. Also, or alternatively, the LEO beam may be “earth fixed” (e.g., where the beam is steered to remain covering a fixed location), for example, until another cell overtakes the coverage area in a discrete and coordinated change.

Due to the altitude of NTN platforms and beam diameter, the round-trip time (RTT) and maximum differential delay may be larger than that of terrestrial systems. In a certain transparent NTN deployment, the RTT may range from 25.77 ms (e.g., LEO @ 600 km altitude) to 541.46 ms (e.g., GEO) and a maximum differential delay may range from 3.12 ms to 10.3 ms. The RTT of a regenerative payload may be approximately half that of a transparent payload (e.g., as a transparent configuration may comprise both service and feeder links). The RTT of a regenerative payload may consider (e.g., may only consider) the service link. A WTRU may perform timing pre-compensation, for example, prior to initial access, which may minimize impact to existing NR systems (e.g., to avoid preamble ambiguity and/or properly time reception windows).

In a pre-compensation procedure, a WTRU may obtain its position via GNSS. For example, the WTRU may obtain its position based on the feeder-link (or common) delay and/or satellite position (e.g., which may be determined via satellite ephemeris data). For example, satellite ephemeris data may be broadcasted (e.g., periodically broadcasted) in system information. For example, satellite ephemeris data may include the satellite speed, direction, and/or velocity. The WTRU may estimate the distance (e.g., and the delay) from the satellite. The WTRU may add the feeder-link delay component, for example, to obtain the WTRU-gNB RTT (e.g., the full WTRU-gNB RTT). The WTRU-gNB RTT may be used to offset timers, reception windows, and/or timing relations. The WTRU may determine (e.g., assume) that frequency compensation may be performed by the network.

In certain scenarios, an NTN may support WTRU mobility and measurement reporting. The difference in Reference Signal Received Power (RSRP) between cell center and cell edge may be less in NTN than in terrestrial systems. Also, or alternatively, an NTN may be associated with a larger region of cell overlap. Measurement-based mobility may be less reliable in an NTN environment. Conditional handover and/or measurement reporting triggers may be performed in NTN. For example, conditional handover and/or measurement reporting triggers may rely on location and time, with details to be confirmed. Enhanced mobility may be supported in LEO deployments where (e.g., due to satellite movement) a stationary WTRU may be expected to perform mobility (e.g., approximately every 7 seconds, for example, depending on deployment characteristics).

Non-terrestrial networks may be associated with large moving cells and reduced effectiveness of measurement-based procedures, for example, due to a reduced signal-strength variation between cell center and cell edge. In certain scenarios, a WTRU's location may be incorporated into one or more procedures such as time/frequency pre-compensation, conditional handover (CHO), measurement reporting, and/or AMF determination. RAT-dependent positioning methods may not be supported in non-terrestrial networks, which may require NTN devices to maintain GNSS information (e.g., accurate GNSS information). NTN capable devices may also be GNSS capable.

Acquisition of GNSS information may be a time and power intensive process, which may cause issues for internet of things (IoT) and reduced capability (RedCap) devices (e.g., where reduced power consumption may be implemented). A subset of IoT and/or RedCap devices (e.g., NB-IoT) may not be capable of supporting GNSS acquisition and data transmission/reception.

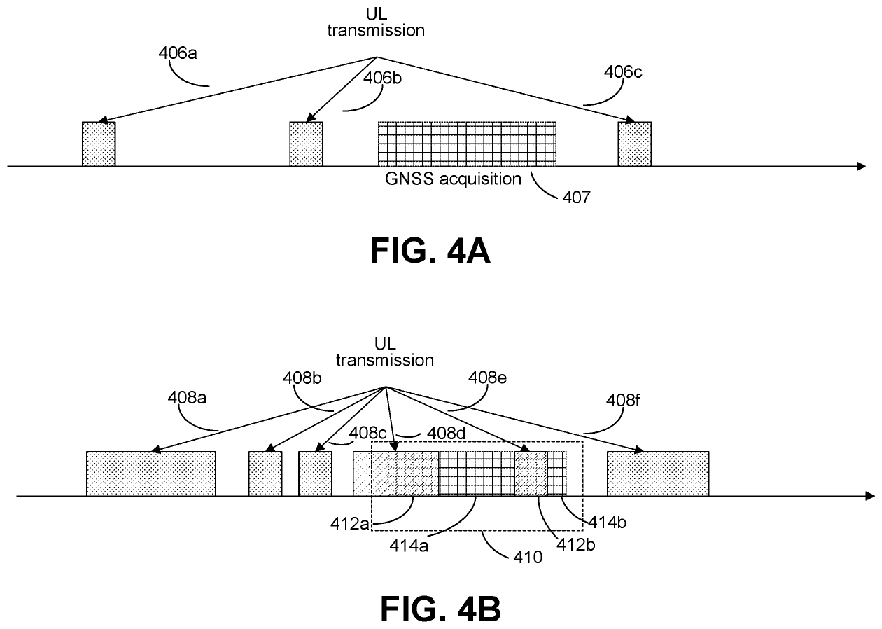

FIGS. 4A and 4B illustrate examples associated with GNSS acquisition. For example, as shown in FIG. 4A, in certain NTN deployments IoT traffic may be (e.g., limited to) short and sporadic traffic 406a,b,c, which may not affect GNSS acquisition 407. The WTRU may suspend user plane and control plane reception and transmission to receive GNSS information during GNSS acquisition 407. Techniques to reduce GNSS acquisition time (e.g., position fix duration) may be implemented (e.g., as it is unlikely that a scheduled transmission/reception would overlap with GNSS acquisition).

As shown in FIG. 4B, in certain NTN deployments, IoT traffic may not be (e.g., limited to) short and sporadic traffic 408a-f, which may increase throughput and/or the probability of collision between a GNSS acquisition window and UL transmission/DL receptions. The WTRU may tune away to acquire GNSS packets unable to be received. Tuning away may comprise re-tuning the WTRU's receiver chain (e.g., antenna) to receive GNSS packets that the WTRU was previously unable to receive with the previous tuning. In some cases, a first receiver (e.g., LTE) and a second receiver (e.g., GNSS) may each be located on a separate chip (e.g., one LTE chip and one GNSS chip). In some limited capability devices (e.g., IoT devices), the two chips may not be able to operate at the same time. If the WTRU is operating the LTE receiver to receive data, then the WTRU may not be able to receive GNSS data and vice-versa. Switching between operating receivers may be referred to herein as “tuning away.” In FIG. 4B, the WTRU may tune away a first receiver to the GNSS receiver to receive and/or send GNSS data (e.g., switching from an LTE receiver to GNSS receiver to receive GNSS data). In other cases, the WTRU may be able to operate the first receiver and the second receiver at the same time, without tuning away.

GNSS acquisition 410 may occur in slots (or subbands) 412a,412b where no UL transmission/DL reception occurs due to the WTRU tuning away. GNSS acquisition 410 may also occur in slots (or subbands) 414a,414b where no UL transmission/reception is scheduled. The timing and/or frequency of UL transmissions/DL receptions and GNSS acquisition may be varied (e.g., by the WTRU, gNB, and/or configuration information) such that the probability of collision is decreased.

To support GNSS acquisition (e.g., which may take place in a GNSS acquisition window) 410 in higher traffic environments, assistance information (AI) may be used for GNSS acquisition 410 (herein referred to as GNSS acquisition assistance information). GNSS acquisition assistance information may be used to facilitate configuration of a measurement gap for GNSS acquisition. For example, GNSS acquisition assistance information may include the time it takes for a WTRU to acquire GNSS. Also, or alternatively, GNSS acquisition assistance information may include the duration of validity for the GNSS information (e.g., how long until a WTRU is to re-acquire GNSS). Techniques to prevent excessive GNSS acquisition may be implemented (e.g., to limit WTRU power consumption).

One or more techniques to report WTRU assistance information and/or support measurement gap configuration for GNSS acquisition may be implemented. One or more techniques to reduce excessive GNSS acquisition and reporting may be implemented (e.g., for power-limited devices).

As disclosed herein, the term “GNSS” may be used to refer to a WTRU's position/location which may be used, for example, in non-terrestrial networks for timing advance calculations. However, the techniques described herein may also, or alternatively, be used with any suitable information (e.g., in lieu of and/or in addition to GNSS information). The terms “GNSS assistance information”, “GNSS acquisition assistance information” and “measurement gap configuration assistance information” may be used interchangeably herein and may be used to describe WTRU reported assistance information (e.g., to aid GNSS acquisition). The terms “IoT”, “NB-IoT” and “eMTC” devices may be used to describe lower-capability devices (e.g., lower-capability devices supported by LTE). However, the techniques described herein may equally apply to other devices, including NR reduced capability (RedCap) devices.

GNSS acquisition and reporting techniques may be performed in consideration of IoT and/or reduced capabilities devices operating in non-terrestrial networks. For example, WTRU assistance information may be used to support GNSS acquisition. Also, or alternatively, excessive GNSS reporting may be reduced.

As described herein, a GNSS acquisition assistance information reporting procedure may be performed. One or more of the following may apply. A WTRU may receive an indication and/or configuration (indication/configuration) associated with GNSS acquisition assistance information reporting (e.g., GNSS AI reporting). For example, the WTRU may receive configuration information for reporting GNSS AI. The indication/configuration may be provided via system information (e.g., if AI is sent in RACH message) and/or via signaling (e.g., RRC configuration and/or signaling). The indication and/or configuration may comprise one or more of the following: an enable/disable flag, reporting triggers (e.g., periodicities, thresholds), the signaling methods to use, prohibit timers, and/or possible measurement gap configurations. For instance, the configuration information may include a reporting trigger threshold that is at least one of a distance threshold or a time offset threshold, for example, as described here.

The WTRU may monitor for trigger conditions associated with GNSS assistance information reporting. For example, a trigger condition may include a NW request. For example, a trigger condition may include a threshold (e.g., last time GNSS reported>time threshold, WTRU location change>number, etc.). For example, a WTRU may periodically send GNSS assistance information reporting. Trigger thresholds may be biased, for example, based on: the WTRU's speed, mobility state estimation, device type, measurements, satellite characteristics, etc.

If the WTRU determines that a triggering condition has been satisfied (e.g., the WTRU determines that a trigger threshold is exceeded), the WTRU may report GNSS assistance information. For example, the WTRU may report GNSS assistance information via a MAC CE (e.g., a GNSS acquisition assistance information MAC CE) and/or via RRC signaling (e.g., included in WTRU capability reporting, WTRU information response, and/or measurement reporting). In certain scenarios, a WTRU may select among one or more signaling methods based on, e.g., the contents of the report, the RRC state, whether AS security has been activated, and/or the triggering condition which caused GNSS acquisition assistance information reporting. For example, GNSS assistance information (GNSS AI) may, for example include one or more of: GNSS validity duration, GNSS acquisition time, characteristics of WTRU movement (e.g., WTRU speed, direction), a preferred measurement gap configuration and/or configuration index, etc. The characteristic of the WTRU may comprise at least one of GNSS acquisition AI, a location change, or change in speed of the WTRU.

As described herein, the GNSS validity duration may include an indication of a time duration associated with a validity of a GNSS acquisition, an indication of a time duration associated with expiration of the GNSS acquisition, or a WTRU location associated with the GNSS acquisition. Further, as also described herein, the GNSS acquisition time may include a time to acquire a GNSS position.

As described herein, excessive GNSS acquisition and/or reporting may be prohibited. One or more of the following may apply. GNSS reporting (e.g., of measurements and/or location information) and GNSS AI reporting (e.g., as described herein) may be subject to one or more techniques to reduce reporting frequency. For example, a WTRU may receive (e.g., via configuration) conditions to prohibit (e.g., temporarily prohibit) GNSS acquisition and/or reporting (e.g., GNSS reporting and/or GNSS AI reporting). The prohibition conditions may apply to: GNSS acquisition, GNSS reporting, and/or GNSS assistance information reporting. For example, the prohibition conditions may include one or more of the following: a prohibit timer (e.g. started upon GNSS acquisition, and/or upon last transmission of GNSS); a condition based on GNSS validity duration (e.g. no reporting and/or re-acquisition until X sec left of GNSS validity); and/or a condition based on WTRU characteristics such as WTRU's location change and/or WTRU's speed (e.g. no reporting GNSS unless location changed by X meters and/or unless WTRU speed>Y m/s).

GNSS reporting may comprise the WTRU reporting (e.g., to the network, gNB) its location information (e.g., GNSS information) obtained via GNSS. GNSS AI reporting may comprise the WTRU reporting additional information (e.g., to the network, gNB, satellite) to support the WTRU acquiring its GNSS information. For example, AI may comprise how long it takes the WTRU to acquire GNSS, how long the WTRU remains valid before it will re-acquire GNSS, etc. The triggers for GNSS reporting and GNSS AI reporting may be different. For example, a trigger for GNSS reporting may be new location information (e.g., GNSS location) being available. While a trigger for GNSS AI reporting may be the increasing of the time it takes to acquire GNSS (e.g., the WTRU is blocked by buildings, trees, and or a tunnel).

A WTRU may receive, via configuration information, at least one prohibition condition configured to prohibit GNSS activity. The GNSS activity may comprise at least one of GNSS acquisition, GNSS reporting, or GNSS assistance information (AI) reporting. The WTRU may identify a trigger related to the GNSS activity. The WTRU may determine whether a prohibition condition is activated. The prohibition condition may comprise a condition based on a prohibition timer, a condition based on GNSS validity duration, and/or a condition based on a characteristic of the WTRU. When the prohibition condition is determined to be active, the WTRU may perform the GNSS activity in response to an override or termination of the prohibition condition and based on the prohibition condition being determined to be active.

As described herein, if GNSS reporting conditions are satisfied (e.g., updated GNSS information is available and/or in response to network request) and prohibition conditions are active, one or more of the following may occur. A WTRU may report GNSS and/or GNSS AI when a number of triggering events for GNSS reporting and/or GNSS AI reporting exceeds a threshold. A WTRU may delay GNSS reporting and/or GNSS AI reporting until prohibition conditions (e.g., one or more or all prohibit conditions) are not active and/or expire. A WTRU may indicate that one or more prohibit conditions are active (e.g., via one or more flags). A WTRU may provide (e.g., send) an indication that GNSS reporting and/or GNSS AI reporting is (or will be) enabled again. For example, separate indications may be provided for GNSS reporting and GNSS AI reporting.

A WTRU may override a prohibition of GNSS reporting and/or GNSS acquisition assistance information reporting. For example, a WTRU may override a prohibition of GNSS reporting and/or GNSS acquisition assistance information reporting if a number of triggering events for GNSS reporting and/or GNSS acquisition assistance information reporting occurring during prohibit time exceeds a threshold. A WTRU may override a prohibition of GNSS reporting and/or GNSS acquisition assistance information reporting if the WTRU receives a NW request (e.g., indication to override prohibit conditions). A WTRU may override a prohibition of GNSS reporting and/or GNSS acquisition assistance information reporting if the GNSS validity timer expires during a prohibit condition. If, for example, GNSS reporting conditions are satisfied and prohibition conditions are not active, the WTRU may report the GNSS information (e.g., measurements and/or location) and/or the GNSS AI information.

The WTRU may perform the GNSS activity when the prohibition condition is determined to be inactive. The characteristic of the WTRU may comprise at least one of GNSS acquisition AI, a location change, or change in speed of the WTRU.

The WTRU may determine the override or the termination of the prohibition condition in response to: one or more triggering events for GNSS reporting or reporting occurring during a prohibit time period, wherein the prohibit time period exceeds a threshold; reception of an explicit request to override; or an expiration of a GNSS validity timer during the prohibit condition.

The WTRU may monitor for one or more trigger conditions when the prohibition condition is determined to be active. The prohibition condition may be based on one or more of the following: a GNSS validity duration, a WTRU location, or a WTRU speed.

The WTRU may, in the performance of the GNSS activity, report via a medium access control (MAC) information element (IE) when GNSS AI comprises GNSS validity duration, and report via a radio resource control (RRC), based on an RRC state, when the GNSS AI comprises a position fix duration.

The WTRU may, when GNSS reporting conditions are satisfied and the prohibit condition is active, do one or more of the following: delay GNSS activity until the prohibit condition is not active or expired, indicate that the prohibit condition is active, or indicate when GNSS activity is to be enabled.

The WTRU may stop transmitting and receiving data signals, control signals, and reference signals (e.g., SSB, PRS, CSI-RS) to receive GNSS information. The WTRU may be an internet of things (IOTs) device. The WTRU may be a reduced capability (RedCap) device.

A WTRU may be configured with a measurement gap (e.g., to support the WTRU's acquisition of GNSS location/positioning information). A measurement gap configuration may be used for devices that are not able to simultaneously acquire GNSS positioning information and transmit/receive data (e.g., NB-IoT and/or reduced capability (RedCap) devices).

GNSS acquisition (e.g., duration and validity) may depend on WTRU capability/device type and/or WTRU-specific characteristics (e.g., the WTRU's movement and speed, which may relate to how frequently GNSS is to be updated). A WTRU may report assistance information to the network, for example, to facilitate measurement gap configuration for GNSS acquisition.

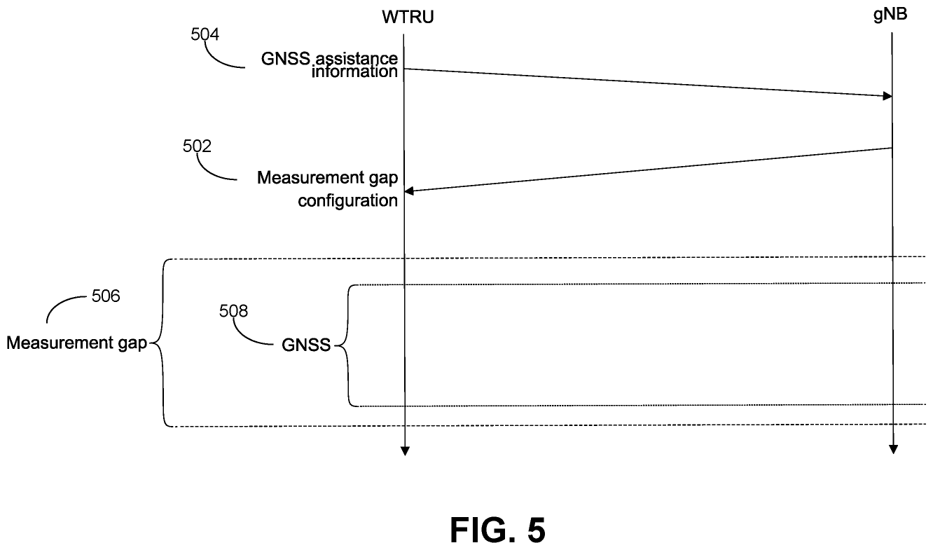

FIG. 5 illustrates an example 500 associated with a measurement gap 506 configuration 502 for GNSS 508 acquisition (e.g., based on WTRU-reported assistance information 504).

Assistance information may include the GNSS 508 acquisition time and/or the validity of the current GNSS 508 location fix. One or more techniques associated with configuration, triggering, reporting, and signaling for GNSS 508 acquisition assistance information may be implemented.

WTRU assistance information may be used for GNSS 508 acquisition 504. One or more of the following may apply. A WTRU may report assistance information 504 to facilitate GNSS 508 acquisition. For example, assistance information 504 may be used, for example, to facilitate measurement gap 506 configuration, to avoid scheduling UL transmission and/or DL receptions during GNSS 508 acquisition, and/or to reduce excessive GNSS 508 acquisition/reporting. In some cases, the measurement gap configuration may be associated with a length of time to suspend WTRU reception and transmission to reacquire GNSS. The WTRU may be an internet of things (IOT) device and/or a reduced capability (RedCap) device.

A WTRU may determine and/or report the validity duration of acquired GNSS 508 information. The validity duration may, for example, include the time which a WTRU may no longer maintain time/frequency synchronization with a network. In an NTN, for example, a WTRU may no longer maintain time/frequency synchronization with a network if the GNSS 508 location used for timing advance reporting is no longer suitable to maintain accurate time synchronization. The validity duration may, for example, include a time in which the WTRU should start GNSS 508 re-acquisition. For example, a GNSS 508 acquisition measurement gap 506 should be started (or alternatively start) at the end of the validity duration. The validity duration may, for example, include the time in which GNSS 508 acquisition should be completed (e.g., at least one GNSS 508 acquisition measurement gap 506 is to be completed by the end of the validity duration). The validity duration may, for example, include the time in which GNSS 508 may not be used for WTRU procedures. For example, upon expiry of the GNSS 508 validity duration, the GNSS 508 location may not be used for timing advance calculation in non-terrestrial networks. The validity duration may, for example, include the time in which GNSS 508 information may not be reported. For example, upon expiration of the GNSS 508 validity duration, the GNSS 508 location may no longer be reported to the network.

A WTRU may maintain a GNSS 508 validity duration, e.g., via a timer. Upon successful GNSS 508 acquisition, the WTRU may start a GNSS 508 validity timer. The duration of the timer may be pre-configured (e.g., via RRC signaling) and/or may be determined by the WTRU (e.g., based on the WTRU's characteristics, such as WTRU speed and capability). The WTRU may include the validity duration within a GNSS 508 assistance information report. Upon successful acknowledgment of the validity duration (e.g., via ACK of the transmission carrying the validity duration), the WTRU may determine that the reported validity duration to be the duration of the validity timer. Upon expiration of the timer, the WTRU may report and/or indicate to the network that the validity duration has expired.

In certain scenarios, the GNSS 508 validity duration may be represented and/or reported. For example, the GNSS 508 validity duration may be represented and/or reported via a time duration (e.g., 10 seconds). For example, the GNSS 508 validity duration may be represented and/or reported via an absolute validity expiration time (e.g., until 12:10:35 UTC time). For example, the GNSS 508 validity duration may be represented and/or reported via a time-of-day dependent validity duration (e.g., between absolute time1 and time2, GNSS 508 may be considered to be valid for x seconds; between absolute time3 and time4, GNSS 508 can be considered to be valid for y seconds, etc.). For example, the GNSS 508 validity duration may be represented and/or reported via a location dependent validity duration (e.g., if the reported GNSS 508 location is between coordinates 1 and coordinates 2, the reported GNSS 508 is considered to be valid for x seconds; if the reported GNSS 508 location is between coordinates 3 and coordinates 4, the reported GNSS 508 location is considered to be valid for y seconds, etc.).

Determination of the validity duration may be based on (e.g., consider) WTRU characteristics, including, for example, WTRU movement, WTRU speed, and/or WTRU capability. A WTRU may be configured to report one or more WTRU characteristics (e.g., such as those listed herein) used to determine the validity duration.

A WTRU may determine and report a GNSS 508 acquisition time. The WTRU may be configured to determine the GNSS 508 acquisition time based on earlier acquisitions. For example, the WTRU may be configured to calculate the acquisition time for GNSS 508 based on the mean/average/median of the last n GNSS 508 acquisitions, for example, where n is a configurable value. For example, the WTRU may be configured to calculate the acquisition time for GNSS 508 based on the mean/average/median of the GNSS 508 acquisitions done within a certain configured period of time. For example, the WTRU may be configured to calculate the acquisition time for GNSS 508 based on a filtered GNSS 508 acquisition time, for example, where the most recent acquisition times have more weight than the earlier ones.

A WTRU may be configured to determine the GNSS 508 acquisition time that is dependent on location ranges and/or time durations. For example, GNSS 508 acquisitions in certain locations may be longer (e.g., locations where there are shadowing elements like trees, tall buildings and/or when the WTRU is indoors). As another example, a WTRU may be more likely to be indoors at certain times of day, and the GNSS 508 acquisition time may be longer during those times. The WTRU may be configured to provide different sets of acquisition times that are dependent on location and/or time of day. For example, a WTRU may provide a first acquisition time duration of X if the WTRU location is between coordinates 1 and 2, and a second acquisition time duration of Y if the WTRU location is between coordinates 3 and 4, etc. Also, or alternatively, a WTRU may be configured to provide first acquisition time duration of A if the time of day is between absolute time 1 and time 2, and a second acquisition time duration of B if the time of day is between absolute time 3 and 4, etc.

A WTRU may be configured with a training period. For example, the training period may include a period during which the WTRU gathers information regarding the acquisition time and the validity duration of the GNSS 508 information. In certain scenarios, the training period may be (e.g., may only be) applicable while the WTRU is in a CONNECTED mode. In certain scenarios, the training period may be (e.g., may only be) applicable while the WTRU is in IDLE/INACTIVE mode. In certain scenarios, the training period may be applicable regardless of the WTRU's RRC state.

A WTRU may report additional assistance information (e.g., other than validity duration and/or acquisition time) to the network. For example, a WTRU may report an accuracy of GNSS 508 information (e.g., whether the GNSS 508 information is coarse and/or fine) to the network. For example, a WTRU may report characteristics of the WTRU's movement (e.g., WTRU speed, WTRU direction, etc.) to the network. For example, a WTRU may report another positioning information (e.g., measurements and/or results associated with: PRS, sPRS, AoA, AoD, multi-RTT, TDOA, etc.) to the network. For example, a WTRU may report characteristics associated with a serving and/or neighboring satellite (e.g., satellite ephemeris, and/or other aspects of satellite assistance information). For example, a WTRU may report a mobility state estimation status. For example, a WTRU may report whether the WTRU GNSS 508 information has been verified by the network. For example, a WTRU may report a preferred (or alternatively requested) measurement gap 506 configuration. If the WTRU reports a preferred measurement gap 506 configuration, the WTRU may be provided/indicated (or alternatively may have stored) with one or more GNSS 508 measurement gap 506 configurations. Also or alternatively, the WTRU may indicate one or more preferred configurations, e.g. via indication of an index and/or measurement gap 506 ID. For example, a WTRU may report a preferred time and/or frequency resources for the measurement gap 506 to occur.

A WTRU may receive an indication and/or configuration to report GNSS 508 acquisition assistance information and/or to control aspects of GNSS 508 acquisition assistance information reporting. The WTRU may, for example, be configured: semi-statically (e.g., via RRC signaling); via an indication in system information, and/or dynamically (e.g. via DCI and/or MAC CE; upon NW request). The configuration may apply (e.g., be active) for the duration of the connection (e.g., only when the WTRU is in RRC CONNECTED state, only when the WTRU is in RRC CONNECTED and/or RRC INACTIVE state, applicable as long as the WTRU is in attached to the network, e.g., even while in RRC IDLE state, etc.). The configuration may apply (e.g., be active) for a given time of day (e.g., until 12:01:03 UTC time). The configuration may apply (e.g., be active) for a given location (e.g., between GNSS 508 coordinates 1 and 2). The configuration may apply (e.g., be active) for the next GNSS 508 acquisition report and/or for X GNSS 508 reports.

A WTRU may have one or more configurations. For example, the WTRU may receive a configuration (e.g., different configuration): per serving cell; for the PCell and/or SPCell (e.g., as compared to the SCell); and/or per MAC entity (e.g., per cell group, one for MCG, one for SCG, etc.).

The indication and/or configuration to report GNSS 508 acquisition assistance information and/or to control aspects of GNSS 508 acquisition assistance information reporting may include an enable/disable/pause GNSS 508 acquisition assistance information reporting flag.

The indication and/or configuration to report GNSS 508 acquisition assistance information and/or to control aspects of GNSS 508 acquisition assistance information reporting may include configurations associated with triggering GNSS 508 acquisition assistance information reporting. For example, configurations associated with triggering GNSS 508 acquisition assistance information reporting may include location/distance-based thresholds (e.g., WTRU moved X meters from last reported location, WTRU is within GNSS 508 coordinates x and y, etc.). For example, configurations associated with triggering GNSS 508 acquisition assistance information reporting may include time-based thresholds (e.g., WTRU reported X seconds ago, time of day is between absolute time1 and time2, etc.). For example, configurations associated with triggering GNSS 508 acquisition assistance information reporting may include periodicities between when GNSS 508 is to be reported. For example, configurations associated with triggering GNSS 508 acquisition assistance information reporting may include data related thresholds.

The indication and/or configuration to report GNSS 508 acquisition assistance information and/or to control aspects of GNSS 508 acquisition assistance information reporting may include an indication of the type of signaling to use (e.g., MAC CE, RRC).

The indication and/or configuration to report GNSS 508 acquisition assistance information and/or to control aspects of GNSS 508 acquisition assistance information reporting may include an indication of whether reporting is applicable during random access. For example, the configuration may indicate that GNSS 508 assistance information reporting may be included in a random-access message. The configuration may also, or alternatively, indicate which random-access message the information is to be included in.

The indication and/or configuration to report GNSS 508 acquisition assistance information and/or to control aspects of GNSS 508 acquisition assistance information reporting may include an indication of the biases to apply to triggering conditions. For example, the configuration may include an indication of whether the WTRU is to apply biases to one or more triggering conditions (e.g., refer to section on “scaling reporting based on WTRU characteristics”).

The indication and/or configuration to report GNSS 508 acquisition assistance information and/or to control aspects of GNSS 508 acquisition assistance information reporting may include an indication of whether to report full assistance information, a subset of information, and/or delta signaling. For example, the WTRU may be configured to report: certain GNSS 508 assistance information (e.g., validity time and GNSS 508 acquisition time); additional assistance information (e.g. GNSS 508 accuracy, characteristics of WTRU movement etc.); and/or the values that have changed (e.g., only the validity time if the GNSS 508 acquisition time has not changed; and/or an empty report if nothing has changed, and/or no report at all).

The indication and/or configuration to report GNSS 508 acquisition assistance information and/or to control aspects of GNSS 508 acquisition assistance information reporting may include an indication of the resources used to report assistance information. For example, the configuration may include an indication that the WTRU can report assistance information on configured grants (e.g., on all configured grants, or on one or more configured grant configurations).

The indication and/or configuration to report GNSS 508 acquisition assistance information and/or to control aspects of GNSS 508 acquisition assistance information reporting may include a set of possible measurement gap 506 configurations for GNSS 508 acquisition.

A WTRU and/or MAC entity may be configured with triggering conditions to report GNSS 508 acquisition assistance information. For example, a WTRU may report GNSS 508 assistance based on reception of a network request. For example, a WTRU may report GNSS 508 assistance based on an indication in system information. For example, a WTRU may report GNSS 508 assistance based on a threshold-based event (e.g., the WTRU moved a certain distance since the WTRU has last reported a GNSS 508 acquisition assistance information, a certain time has elapsed since the WTRU has last reported a GNSS 508 acquisition assistance information, etc.). For example, a WTRU may report GNSS 508 assistance information if the WTRU is in a certain location (e.g., trigger GNSS 508 acquisition assistance information if the WTRU determines that it is located between GNSS 508 coordinates x and y for the first time, etc.). For example, a WTRU may report GNSS 508 assistance information during certain times of day (e.g., trigger GNSS 508 acquisition assistance information at absolute times t1, t2, etc.). For example, a WTRU may periodically report GNSS 508 assistance information. For example, a WTRU may report GNSS 508 assistance information if the validity time/duration of the last reported GNSS 508 expires (e.g., and/or soon to expire). For example, a WTRU may report GNSS 508 assistance information if the WTRU has an UL grant and does not have enough UP/CP data to fill that grant (e.g., assistance information piggy-backed to use the left-over UL resources). For example, a WTRU may report GNSS 508 assistance information if the WTRU is scheduled during a time that GNSS 508 is about to expire (e.g., the GNSS 508 validity is set to expire during and/or some time before the WTRU is scheduled with a DL reception and/or UL transmission). For example, a WTRU may report GNSS 508 assistance information based on RRC state transitions (e.g., when establishing/resuming a connection). For example, a WTRU may report GNSS 508 assistance information based on RRM measurement reporting. For example, a WTRU may report GNSS 508 assistance information based on RLF reporting.

A WTRU may report and/or signal GNSS 508 assistance information (e.g., to support WTRU acquisition of GNSS 508 location) via one or more of the following: a MAC CE; RRC signaling; RACH signaling (e.g., Msg3, MsgA, Msg5); UCI; PUSCH resources; and/or PUCCH resources.

A WTRU may report assistance information using one or more (e.g., multiple) techniques. For example, a WTRU may select a given assistance information reporting technique based on the type of information to be transmitted. For example, if the information to be transmitted includes WTRU privacy (e.g., location information), the WTRU may transmit the assistance information via RRC signaling. Also, or alternatively, if information is transmitted during random access and/or if an RRC connection with AS security has not been established (e.g., if the WTRU is in RRC IDLE and/or RRC INACTIVE state), the WTRU may transmit message via PUSCH resources and/or via MAC CE.

For example, a WTRU may select a given assistance information reporting technique based on the device type and/or device capability (e.g., eMTC and/or WTRU devices may use RRC signaling, NB-IoT devices may use MAC CE, etc.).

For example, a WTRU may select a given assistance information reporting technique based on the type of random access (e.g., a WTRU performing 2-step RACH may include a message within MSGA, a WTRU performing 4-step RACH may include message within Msg 3 and/or Msg 5, etc.).

For example, a WTRU may select a given assistance information reporting technique based on a gNB configuration (e.g., a WTRU may be configured to report information via MAC CE and/or RRC signaling).

A WTRU may select a given assistance information reporting technique based on the event and/or indication that triggered the report. For example, if a WTRU performs assistance information reporting based upon expiration of a validity timer (e.g., maintained in MAC layer), the assistance information may be reported via MAC CE. Also, or alternatively, if a WTRU performs assistance information reporting based on an RRC state transition, the assistance information may be reported via RRC signaling.

For example, a WTRU may select a given assistance information reporting technique based on the RRC state the WTRU is in (e.g., a WTRU in RRC IDLE/INACTIVE may not use RRC signaling to transmit assistance information, a WTRU may report information using RRC signaling in RRC_Connected state, etc.).

For example, a WTRU may select a given assistance information reporting technique based on whether AS security (e.g., and/or other forms of security) has been activated. For example, a WTRU may use RRC signaling if (e.g., only if) AS security has been activated. Otherwise, a WTRU may use a MAC CE and/or other signaling.

A WTRU may transmit GNSS 508 acquisition assistance information via a MAC CE (e.g., the GNSS 508 assistance information MAC CE). For example, the GNSS 508 assistance information MAC CE may include one or more of the following information fields: an “activation/deactivation” request field (e.g., for configuration of a measurement gap 506, wherein the WTRU may indicate that it would like a specific measurement gap 506 activated); a cell ID field (e.g., where a measurement gap 506 applies); and/or WTRU assistance information for GNSS 508 acquisition (e.g., as described herein).

A WTRU may transmit one or more types of GNSS 508 assistance information MAC CEs. For example, a WTRU may transmit an “essential” and/or “truncated” GNSS 508 assistance information MAC CE, which may include a subset of information (e.g., information used to configure a measurement gap 506, such as GNSS 508 acquisition time and validity duration). For example, a WTRU may transmit a “full” GNSS 508 assistance information MAC CE, which may include additional assistance information (e.g., one or more of additional information fields described herein).

A WTRU may determine whether to report a truncated GNSS 508 assistance information MAC CE and/or a full GNSS 508 assistance information MAC. For example, a WTRU may determine whether to report full and/or truncated GNSS 508 assistance information MAC CE based on the amount of available resources the WTRU may report (e.g., if the remaining available resources can support the full and/or truncated MAC CE and any additional header information). For example, a WTRU may determine whether to report full and/or truncated GNSS 508 assistance information MAC CE based on a network configuration (e.g., the WTRU may be configured to report truncated and/or full MAC CE). For example, a WTRU may determine whether to report full and/or truncated GNSS 508 assistance information MAC CE based on a logical channel prioritization (LCP) procedure.

A WTRU may receive (e.g., via configuration, system information, based on specification, and/or dedicated signaling) a set of possible measurement gap 506 configurations associated with GNSS 508 acquisition. For example, each measurement gap 506 configuration may have an associated index and/or ID. The WTRU may transmit a MAC CE that may indicate a preferred GNSS 508 measurement gap 506 configuration, and an indication to activate/deactivate the measurement gap 506.

A WTRU may report GNSS 508 acquisition assistance information via RRC signaling. For example, GNSS 508 acquisition assistance information may be included within a measurement report (e.g., the WTRU may piggy-back additional assistance information within the measurement report, which may be subject to an explicit configuration).

A WTRU may include GNSS 508 acquisition assistance information with WTRU capability reporting. For example, a WTRU may indicate that it is capable of reporting GNSS 508 assistance information, and/or may indicate that it can indicate one or more pieces of information (e.g., one or more of the WTRU assistance information described herein).

A WTRU may include GNSS 508 acquisition assistance information with a WTRU information request. For example, the WTRU may receive an indication to report information via an WTRU information request message. The indication may include specific types of information to include (e.g., one or more of the WTRU assistance information described herein). The WTRU may respond with a WTRU information response message, and include one or more of the requested pieces of information, if available.

A WTRU may report GNSS 508 assistance information during a Random Access procedure.

The WTRU may suspend user plane and/or control plane reception and transmission to receive GNSS information. Reporting of assistance information during random access may be controlled, for example, by an indication in system information and/or a message (e.g., an RRC Release with suspend message, which may be transmitted upon transition from RRC Connected to RRC INACTIVE state). The WTRU may be provided with an indication of which random access message to include GNSS 508 assistance information in (e.g., Msg3, MsgA and/or Msg5). The WTRU may be provided with an indication to enable/disable reporting during random access. The WTRU may be provided with an indication of the information to include within the assistance information.

A WTRU may receive a measurement gap 506 configuration used for GNSS 508 reporting.

The measurement gap 506 configuration may, for example, include a default measurement gap 506, and/or a WTRU-specific measurement gap 506 (e.g., in response to assistance information reporting from the WTRU). A measurement gap 506 may indicate, for example: a set of time and/or frequency resources which a WTRU may perform GNSS 508 acquisition; and/or an index corresponding to a pre-configured, pre-provisioned, and/or stored measurement gap 506 configuration.

During a measurement gap 506, a WTRU may acquire GNSS 508. During a measurement gap 506, a WTRU may ignore scheduled UL transmission and/or DL receptions. For example, a WTRU may determine whether to ignores UL transmissions and/or DL receptions based on the type of scheduling associated with the UL transmission and/or DL reception (e.g. whether the transmission/reception is dynamic, and/or based on semi-persistent scheduling/configured grant), the priority of the UL transmission and/or DL reception (e.g. if the transmission is high priority), and/or the type of transmission (e.g. if the transmission/reception is data and/or control signaling).

If a WTRU has a valid GNSS 508 location during a measurement gap 506, the WTRU may not perform GNSS 508 acquisition. If a WTRU has a valid GNSS 508 location during a measurement gap 506, the WTRU may use the measurement gap 506 for other purposes (e.g., perform radio link monitoring measurements, perform positioning measurements not related to GNSS 508, enter DRX).

In certain scenarios, the WTRU may receive a measurement gap 506 configuration for other purposes, such as positioning and/or radio link monitoring (e.g., to perform measurements for radio-link monitoring). A WTRU may re-purpose a measurement gap 506 for GNSS 508 acquisition. For example, WTRU may determine whether to re-purpose a measurement gap 506 configured for other purposes if the GNSS 508 validity duration has expired. For example, WTRU may determine whether to re-purpose a measurement gap 506 configured for other purposes if the GNSS 508 validity is about to expire (e.g., if the GNSS 508 validity duration has X seconds remaining). For example, WTRU may determine whether to re-purpose a measurement gap 506 configured for other purposes if the GNSS 508 validity will expire during a future scheduling (e.g., for an UL transmission and/or DL reception). For example, WTRU may determine whether to re-purpose a measurement gap 506 configured for other purposes if the measurement gap 506 configuration is sufficient for GNSS 508 acquisition (e.g., if the measurement gap 506 is contains sufficient time/frequency resources to perform GNSS 508 acquisition)

As described herein, the frequency of GNSS 508 acquisition and reporting may be reduced. One or more of the following may apply. Acquisition of GNSS 508 may be time consuming and power intensive, for example, depending on the WTRU's capability and/or the required accuracy of GNSS 508. Power and time consumption may be further increased in IoT NTN scenarios, for example, where devices may suspend transmission/reception to acquire GNSS 508 and/or where WTRU power consumption should be minimized.

A WTRU may receive a configuration to prohibit GNSS 508 acquisition and/or reporting of GNSS 508 information (e.g., GNSS 508 prohibition configuration). A GNSS 508 prohibition configuration may be, for example, semi-statically configured (e.g., via RRC configuration). A GNSS 508 prohibition configuration may be, for example, indicated in system information (e.g., within an NTN-specific system information block like SIB31/32). A GNSS 508 prohibition configuration may be, for example, dynamically indicated (e.g., within a DCI indication, and/or indicated within a NW request for GNSS 508 location information).

A GNSS 508 prohibition configuration may include one or more of the following: a prohibition duration; conditions for updating a variable length timer; conditions to override prohibition; an indication of the WTRU behavior during prohibition period; and/or configurations associated with prohibition method (e.g., timers and duration, and/or thresholds and events for conditional prohibitions).

A WTRU may be configured GNSS 508 prohibition configurations, for example, to prevent excessive GNSS 508 reporting. For example, GNSS 508 prohibition configurations may be activated/deactivated and/or configured by the network.

A WTRU may be configured with prohibition timer. For example, the prohibition timer may apply to GNSS 508 acquisition, and/or GNSS 508 reporting. In certain scenarios, a WTRU may be configured with multiple prohibition timers (e.g., a timer for GNSS 508 acquisition and a timer for GNSS 508 reporting). While the prohibition timer is running, the WTRU may be prevented from GNSS 508 acquisition and/or reporting. The WTRU may start and/or restart the prohibit timer. For example, the WTRU may start and/or restart the prohibit timer after acquisition of GNSS 508 location information. For example, the WTRU may start and/or restart the prohibit timer after GNSS 508 information reporting after acknowledgment of successful reception (e.g., upon reception of HARQ-ACK to the transmission which contained GNSS 508 report). The WTRU may stop the prohibition timer. For example, the WTRU may stop the prohibition timer upon transition of RRC connection state (e.g., upon transition to IDLE and/or INACTIVE state). For example, the WTRU may stop the prohibition timer upon a radio link failure (RLF). For example, the WTRU may stop the prohibition timer upon BFD. For example, the WTRU may stop the prohibition timer upon initiation of a random-access procedure.

A WTRU may scale triggering events and/or conditions for GNSS 508 reporting (e.g., to increase and/or decrease the frequency of reporting when GNSS 508 as desired). For example, a WTRU may scale GNSS 508 reporting via an application of a bias and/or offset. If, for example, one or more conditions have been met (e.g., if the WTRU is considered in a low-mobility state), the WTRU may apply a bias to extend GNSS 508 reporting periodicity (e.g., and/or to extend a prohibit timer duration). For example, a WTRU may scale GNSS 508 reporting based on device type. For example, a WTRU may scale GNSS 508 reporting based on the WTRU's mobility state (e.g., whether the WTRU is stationary and/or moving, WTRU speed and/or velocity if it is moving, etc.). For example, a WTRU may scale GNSS 508 reporting based on whether measurement relaxation is active. For example, a WTRU may scale GNSS 508 reporting based on the amount of buffered data (e.g., UP data, CP data, all data, data from specific bearers, etc.). For example, a WTRU may scale GNSS 508 reporting if the WTRU is scheduled (e.g., duration of packet transmission). For example, a WTRU may scale GNSS 508 reporting based on the remaining validity time for that last reported GNSS 508 location. For example, a WTRU may scale GNSS 508 reporting based on the current WTRU location (e.g., more frequent reports when the WTRU is between locations 1 and 2, etc.). For example, a WTRU may scale GNSS 508 reporting based on the current time of day (e.g., more frequent reports between absolute times 1 and 2, etc.).

As described herein, a WTRU may be configured with a GNSS 508 acquisition and/or reporting prohibition timer. The WTRU may start and/or restart the timer, for example, each time it performs a GNSS 508 acquisition and/or report to the network. While the prohibition timer is running, the WTRU may not perform further GNSS 508 acquisition and/or reports (e.g., until the prohibition timer expires). The timer may be applied to either GNSS 508 acquisition and/or reporting. One or more of the following may apply.

A WTRU may ignore the configured GNSS 508 reporting trigger conditions associated with the prohibition timer, for example, until another event triggers GNSS 508 acquisition and reporting. The WTRU may send an up-to-date GNSS report (e.g., most up-to-date GNSS report), which may be the same as previously reported GNSS 508 location. The WTRU may indicate that an updated GNSS is not available. For example, the WTRU may also, or alternatively, indicate when updated GNSS can be re-acquired. The WTRU may delay GNSS 508 reporting until after the prohibition timer expires. After the prohibition timer expires, the WTRU may re-acquire GNSS 508 and reports. In certain scenarios, a WTRU may be configured with a prohibition timer for reporting but not for acquisition). If the WTRU is configured with a prohibition timer for reporting but not for acquisition, the WTRU may perform a GNSS 508 acquisition before the timer expires and/or may delay reporting until after the timer expires.

The prohibition timer value may be fixed. The prohibition timer may vary (e.g., depending on a number of conditions). For example, a WTRU moving at higher speeds may use a shorter prohibition timer (e.g., to allow more frequent reporting). The WTRU may detect speed based on GNSS 508 acquisition, a change of RSRP, and/or a change of cell. The WTRU may use a different prohibition timer length, for example, based on the type of service and/or bearer. The WTRU may use a different timer length, for example, based on radio conditions. For example, if a measured RSRP is below a threshold, the WTRU may use a shorter prohibition timer.

A WTRU may be prohibited from sending any SR and/or BSR to request a transmission of a GNSS 508 report while the prohibition timer is running. Also, or alternatively, a WTRU may include a GNSS 508 report in an already scheduled transmission if, for example, a received uplink grant provides enough resources to include the report as well as any other pending higher priority data.

A WTRU may override prohibition of GNSS 508 reporting, which may be subject to a configuration. One or more of the of the following may apply. A WTRU may override prohibition of GNSS 508 reporting based on the type of trigger condition that caused GNSS 508 acquisition and reporting. For example, if GNSS 508 acquisition and/or reporting is periodic and/or WTRU event triggered, an explicit request from the network may be a prohibition of GNSS 508 reporting/acquisition. A WTRU may override prohibition of GNSS 508 reporting based on NW request (e.g., the NW may override prohibition based on explicit flag). A WTRU may override prohibition of GNSS 508 reporting implicitly, for example, if a (e.g., any) RRC reconfiguration is received. A WTRU may restart the prohibition timer after changing its state (e.g., RRC state). For example, if the WTRU moves to RRC_INACTIVE then returns to RRC_CONNECTED, the prohibition timer may be restarted. A WTRU may override prohibition of GNSS 508 reporting following RLF recovery and/or re-establishment. A WTRU may override prohibition of GNSS 508 reporting following a (e.g., any) cell change (e.g., cell reselection, and/or handover). A WTRU may override prohibition of GNSS 508 reporting if one or more (e.g., multiple) triggering conditions have been met (e.g., the number of fulfilled triggering conditions employed to override may be configured).

A WTRU may receive, via configuration information, at least one prohibition condition configured to prohibit GNSS activity. The GNSS activity may comprise at least one of GNSS acquisition, GNSS reporting, or GNSS assistance information (AI) reporting. The WTRU may identify a trigger related to the GNSS activity. The WTRU may determine whether a prohibition condition is activated. The prohibition condition may comprise a condition based on a prohibition timer, a condition based on GNSS validity duration, or a condition based on a characteristic of the WTRU. When the prohibition condition is determined to be active, the WTRU may perform the GNSS activity in response to an override or termination of the prohibition condition and based on the prohibition condition being determined to be active.

Upon satisfaction of an override condition, a WTRU may report (e.g., immediately report), for example, an available (e.g., the latest available) GNSS 508 information and/or as soon as updated GNSS 508 information has been acquired (e.g., if the GNSS 508 information is the same as the previously reported GNSS 508 information). Also, or alternatively, upon satisfaction of an override condition, the WTRU may acquire (e.g., immediately acquire) GNSS 508 information.

As described herein, a WTRU may be configured to perform a GNSS 508 acquisition assistance information reporting procedure. One or more of the following may apply.

A WTRU may receive a configuration for GNSS 508 acquisition assistance information reporting (e.g., GNSS 508 AI reporting). The GNSS 508 acquisition AI reporting configuration may be provided/received via RRC signaling (e.g., via a GNSS 508 acquisition AI IE). The GNSS 508 acquisition AI reporting configuration may be applied per MAC entity and/or per serving cell. The GNSS 508 acquisition AI IE may include one or more of the following information fields (e.g. RRC parameters): an enable/disable indication; conditions to trigger GNSS 508 acquisition AI reporting (e.g. reporting thresholds); signaling methods to report GNSS 508 acquisition AI (e.g. via RRC and/or MAC CE); information to include in GNSS 508 acquisition AI reporting (e.g. the GNSS 508 validity duration and/or GNSS 508 acquisition time); and/or prohibition conditions to reduce excessive reporting (e.g. a prohibition timer duration, and/or scaling biases for report triggering).

Upon reception of a GNSS 508 acquisition AI configuration, a WTRU may monitor for one or more of the following: an indication to report GNSS 508 acquisition AI; reporting triggering conditions (e.g. thresholds based on WTRU movement, remaining time in GNSS 508 validity duration, change in GNSS 508 location as compared to the last successfully reported GNSS 508 location information, etc.); and/or the status of a GNSS 508 validity timer.

A WTRU may trigger GNSS 508 acquisition AI reporting. For example, a WTRU may trigger GNSS 508 acquisition AI reporting if the WTRU detects that one or more GNSS 508 reporting triggering conditions have been satisfied. For example, a WTRU may trigger GNSS 508 acquisition AI reporting if the WTRU receives an indication to report GNSS 508 acquisition AI. For example, a WTRU may trigger GNSS 508 acquisition AI reporting upon expiration of a GNSS 508 validity timer. A WTRU may report GNSS 508 assistance information via, for example, a MAC CE and/or via RRC signaling (e.g., via measurement reporting, WTRU information response, and/or WTRU capability signaling.

Upon transmission of GNSS 508, a WTRU may start and/or restart a GNSS 508 validity duration timer. Also, or alternatively, a WTRU may start and/or restart a GNSS 508 validity duration timer upon successful acquisition of GNSS 508 information and/or upon reception of HARQ feedback (e.g., ACK) for a transmission carrying GNSS 508 acquisition AI and/or GNSS 508 information.

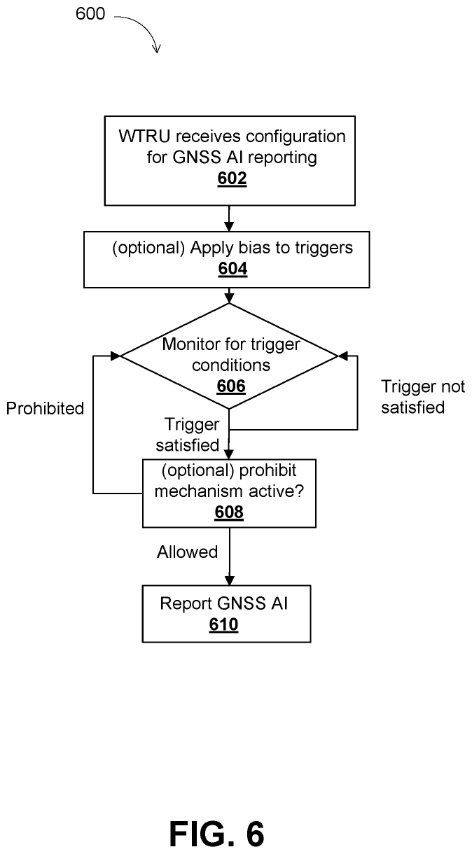

FIG. 6 illustrates an example 600 associated with a GNSS acquisition AI reporting procedure. A WTRU may receive configuration for GNSS AI reporting 602. The WTRU may be an internet of things (IOT) device and/or a reduced capability (RedCap) device. The configuration information for GNSS AI reporting may comprise one or more enable/disable flags, reporting thresholds, and/or biasing conditions. The WTRU may receive configuration information for reporting Global Navigation Satellite System (GNSS) assistance information (AI). The configuration information may comprise a reporting trigger threshold that is at least one of a distance threshold or a time offset threshold.

A WTRU may apply scaling biases 604 (e.g., based on WTRU speed, WTRU velocity, WTRU acceleration, mobility state estimation, and/or satellite characteristics) and/or consider additional prohibition mechanisms (e.g., if a GNSS acquisition assistance information prohibit timer is running). For example, a WTRU may monitor for trigger conditions 606. The WTRU may apply scaling biases and/or consider additional prohibition techniques when evaluating reporting triggering conditions and/or in response to a reporting triggering condition being satisfied or not being satisfied. The WTRU may modify the distance threshold or the time offset threshold based on one or more of a speed of the WTRU, a mobility state of the WTRU, or at least one characteristic of a satellite of a non-terrestrial network. When a trigger is not satisfied, the WTRU may continue to monitor for trigger conditions 606.

At 608, when a trigger is satisfied, the WTRU may determine if a prohibit mechanism is active that prohibits the WTRU from acquiring and/or reporting GNSS (e.g., based on a prohibition timer). The trigger being satisfied may comprise the WTRU determining that the reporting trigger threshold is exceeded. The reporting trigger threshold may be exceeded when the WTRU is scheduled to transmit or receive a transmission at a time that is less than the time offset threshold from the GNSS validity duration expiry. The reporting trigger threshold may be exceeded when a current location of the WTRU exceeds the previously reported WTRU location by a configured threshold. One or more of the following may apply.

A WTRU may receive (e.g., via configuration) prohibition conditions (e.g., to prevent GNSS reporting and/or acquisition). A GNSS reporting prohibition configuration may be received, for example, via RRC signaling (e.g., via a GNSS prohibition IE), and may apply per MAC entity and/or per serving cell. For example, the GNSS prohibition IE may include one or more of the following: an indication to enable/disable prohibition; a prohibition timer duration; and/or scaling factors that may be applied to GNSS reporting triggering conditions (e.g., based on WTRU speed and/or mobility state estimation). A WTRU may receive, via configuration information, at least one prohibition condition configured to prohibit GNSS activity. The GNSS activity may comprise at least one of GNSS acquisition, GNSS reporting, or GNSS assistance information (AI) reporting. The WTRU may identify a trigger related to the GNSS activity. The WTRU may determine whether a prohibition condition is activated. The prohibition condition may comprise a condition based on a prohibition timer, a condition based on GNSS validity duration, or a condition based on a characteristic of the WTRU. When the prohibition condition is determined to be active, the WTRU may perform the GNSS activity in response to an override or termination of the prohibition condition and based on the prohibition condition being determined to be active.

At 610, if allowed, the WTRU may report GNSS AI. The WTRU may report the GNSS AI using a MAC CE, RRC, a measurement report, and/or capability signaling. The GNSS AI may comprise one or more of a GNSS validity duration, a GNSS acquisition time, a measurement gap configuration, and/or a configuration index. The GNSS validity duration may comprise an indication of a time duration associated with a validity of a GNSS acquisition, an indication of a time duration associated with expiration of the GNSS acquisition, and/or a WTRU location associated with the GNSS acquisition. The GNSS acquisition time may comprise a time to acquire a GNSS position. In some cases, the WTRU may receive the measurement gap configuration based on the reporting trigger threshold being exceeded. In some cases, the measurement gap configuration may be associated with a length of time to suspend WTRU reception and transmission.

The WTRU may perform the GNSS activity when the prohibition condition is determined to be inactive. The characteristic of the WTRU may comprise at least one of GNSS acquisition AI, a location change, or change in speed of the WTRU. The WTRU may determine the override or the termination of the prohibition condition in response to: one or more triggering events for GNSS reporting or reporting occurring during a prohibit time period, wherein the prohibit time period exceeds a threshold; reception of an explicit request to override; or an expiration of a GNSS validity timer during the prohibit condition. The WTRU may monitor for one or more trigger conditions when the prohibition condition is determined to be active. The prohibition condition may be based on one or more of the following: a GNSS validity duration, a WTRU location, or a WTRU speed.

The WTRU may, in the performance of the GNSS activity, report via a medium access control (MAC) information element (IE) when GNSS AI comprises GNSS validity duration, and report via a radio resource control (RRC), based on an RRC state, when the GNSS AI comprises a position fix duration. The WTRU may, when GNSS reporting conditions are satisfied and the prohibit condition is active, do one or more of the following: delay GNSS activity until the prohibit condition is not active or expired, indicate that the prohibit condition is active, or indicate when GNSS activity is to be enabled. The WTRU may stop transmitting and receiving data signals to receive GNSS information. The WTRU may be an internet of things (IOTs) device. The WTRU may be a reduced capability (RedCap) device.

The WTRU may report the GNSS AI using a different type of signaling based on reporting the GNSS validity duration or the GNSS acquisition time. For example, the WTRU may use signal type A (e.g., MAC CE) for reporting GNSS validity duration and signal type B for reporting GNSS acquisition time (e.g., RRC). The WTRU may transmit/send, to the gNB, a GNSS AI location report using a medium access control (MAC) information element (IE). In some cases, the GNSS AI may be included in a measurement report. In some cases, the WTRU may report the GNSS AI using WTRU capability signaling.

Upon transmission of GNSS reporting, a WTRU may start and/or restart a GNSS reporting prohibition timer. During the prohibition timer, a WTRU may be restricted and/or prevented from reporting GNSS location information. Also, or alternatively, a WTRU may start and/or restart a GNSS prohibition timer upon successful acquisition of GNSS information and/or upon reception of HARQ feedback (e.g. ACK) for a transmission carrying GNSS information and/or GNSS report.

In certain scenarios, GNSS reporting may be triggered while one or more prohibition conditions are active/in effect. If GNSS reporting has been triggered and one or more prohibit conditions are active/in effect, a WTRU may delay reporting until the prohibition conditions (e.g., one or more and/or all prohibition conditions) are not active and/or expired. If GNSS reporting has been triggered and one or more prohibit conditions are active/in effect, a WTRU may indicate that one or more prohibition conditions are active (e.g. via flag). If GNSS reporting has been triggered and one or more prohibit conditions are active/in effect, a WTRU may provide (e.g., send) an indication of when GNSS reporting and/or GNSS AI reporting is (or will be) enabled again.

A WTRU may override prohibition conditions for GNSS reporting and/or GNSS acquisition AI reporting, which may be further subject to additional conditions. For example, the additional conditions may comprise: a number of triggering events during prohibition time exceeding a threshold; a network (NW) request; and/or upon GNSS validity expiration.

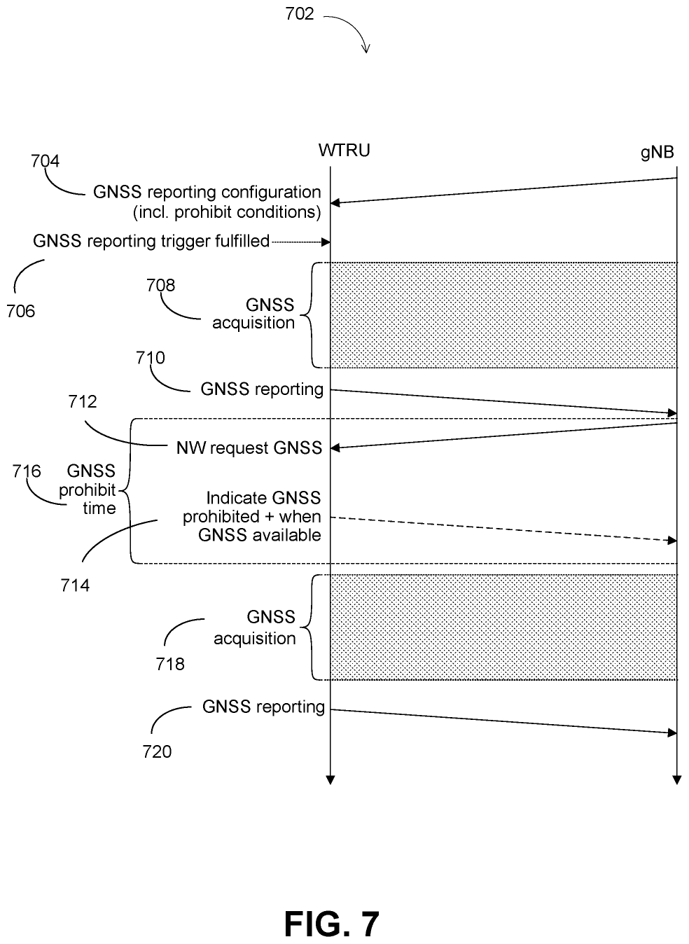

FIG. 7 illustrates an example 702 associated with prohibition of GNSS (e.g., and/or GNSS acquisition assistance information) reporting.

Prohibition conditions may also, or alternatively, apply to GNSS acquisition AI reporting. Separate configurations and/or indications may be provided for GNSS reporting and GNSS AI reporting. Separate prohibition timers may be maintained for GNSS reporting and GNSS assistance information reporting.

The gNB may send the WTRU GNSS reporting configuration information, including prohibit conditions 704. The WTRU may be an internet of things (IOTs) device. The WTRU may be a reduced capability (RedCap) device. The prohibition condition may comprise a condition based on a prohibition timer, a condition based on GNSS validity duration, or a condition based on a characteristic of the WTRU. The WTRU may receive configuration information for reporting Global Navigation Satellite System (GNSS) assistance information (AI). The configuration information may comprise a reporting trigger threshold that is at least one of a distance threshold or a time offset threshold. At 706, the WTRU may determine that the reporting trigger is fulfilled (e.g., reporting trigger threshold is exceed). The reporting trigger threshold may be exceeded when the WTRU is scheduled to transmit or receive a transmission at a time that is less than the time offset threshold from the GNSS validity duration expiry. The reporting trigger threshold may be exceeded when a current location of the WTRU exceeds the previously reported WTRU location by a configured threshold.

After the GNSS reporting trigger is fulfilled 706, the WTRU may commence GNSS acquisition 708. The WTRU may suspend user plane and control plane reception and transmission to receive GNSS information. The WTRU may stop transmitting and receiving data signals to receive GNSS information. Then, the WTRU may report 710 the GNSS AI to the gNB. During GNSS prohibit time 716, the network (e.g., gNB) may send a request (e.g., gNB sends and WTRU receives) for GNSS AI 712. At 714, the WTRU may transmit one or more messages to gNB indicating that GNSS AI acquisition and/or reporting is prohibited and when the GNSS AI acquisition and/or reporting will become available. At 718, the WTRU may perform GNSS acquisition.

At 720, the WTRU may report (e.g., send, transmit, etc.) GNSS AI to the gNB. The WTRU may report the GNSS AI using a MAC CE, RRC, a measurement report, and/or capability signaling. The GNSS AI may comprise one or more of a GNSS validity duration, a GNSS acquisition time, a measurement gap configuration, and/or a configuration index. The GNSS validity duration may comprise an indication of a time duration associated with a validity of a GNSS acquisition, an indication of a time duration associated with expiration of the GNSS acquisition, and/or a WTRU location associated with the GNSS acquisition. The GNSS acquisition time may comprise a time to acquire a GNSS position. The WTRU may determine the override or the termination of a prohibition condition in response to: one or more triggering events for GNSS reporting or reporting occurring during a prohibit time period, wherein the prohibit time period exceeds a threshold; reception of an explicit request to override; or an expiration of a GNSS validity timer during the prohibit condition.

The WTRU may, in the performance of the GNSS activity, report via a medium access control (MAC) information element (IE) when GNSS AI comprises GNSS validity duration, and report via a radio resource control (RRC), based on an RRC state, when the GNSS AI comprises a position fix duration. The WTRU may, when GNSS reporting conditions are satisfied and the prohibit condition is active, do one or more of the following: delay GNSS activity until the prohibit condition is not active or expired, indicate that the prohibit condition is active, or indicate when GNSS activity is to be enabled.

The WTRU may report the GNSS AI using a different type of signaling based on reporting the GNSS validity duration or the GNSS acquisition time. For example, the WTRU may use signal type A (e.g., MAC CE) for reporting GNSS validity duration and signal type B for reporting GNSS acquisition time (e.g., RRC based on an RRC state), vice versa, or combination of two or more signal types.

A WTRU may receive, via configuration information, at least one prohibition condition configured to prohibit GNSS activity. The GNSS activity may comprise at least one of GNSS acquisition, GNSS reporting, or GNSS assistance information (AI) reporting. The WTRU may identify a trigger related to the GNSS activity. The WTRU may determine whether a prohibition condition is activated. The prohibition condition may comprise a condition based on a prohibition timer, a condition based on GNSS validity duration, or a condition based on a characteristic of the WTRU. When the prohibition condition is determined to be active, the WTRU may perform the GNSS activity in response to an override or termination of the prohibition condition and based on the prohibition condition being determined to be active.

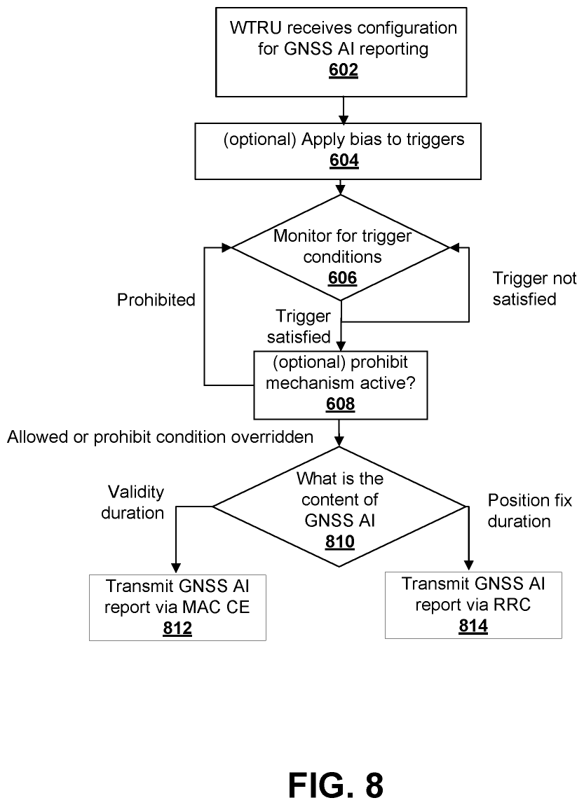

FIG. 8 illustrates another example associated with a reporting procedure. At 602, the WTRU may receive configuration for GNSS AI reporting. In addition to the configuration information of FIG. 6, the configuration information in FIG. 8 may further comprise reporting thresholds related to distance and time (e.g., distance X, time offset T) and/or prohibit mechanisms. At 604, the WTRU may apply one or more biases to the triggers the WTRU. At 606, the WTRU may monitor for trigger conditions. The WTRU may monitor the reporting trigger threshold to determine if the reporting trigger threshold has been exceeded or not. The trigger conditions may comprise whether the WTRU has moved a configured distance X from last reported location and/or whether the WTRU is scheduled (transmit or receive) within a time offset T from the GNSS validity duration expiry. At 608, may determine if one or more prohibit mechanisms is active. Prohibit mechanisms may comprise one or more prohibit timers and/or override conditions (e.g., explicit network requests, validity duration expiry).

At 810, if GNSS reporting and/or acquiring is allowed and/or if a prohibit condition is overridden, the WTRU may determine what the content of the GNSS AI is. At 812, if the GNSS AI comprises validity duration, the WTRU may transmit a GNSS AI report via a MAC CE. At 814, if the GNSS AI comprises position fix duration, the WTRU may transmit a GNSS AI report via RRC. The RRC signaling may comprise one or more measurement reports, capability signaling, setup/resume message.

What is claimed is:

1.-30. (canceled)

31. A wireless transmit receive unit (WTRU) comprising:
a processor configured to:
receive configuration information for reporting Global Navigation Satellite System (GNSS) assistance information;
after a change in radio resource control (RRC) state of the WTRU, send a first report comprising GNSS assistance information via RRC signaling, wherein the GNSS assistance information comprises a GNSS acquisition time and a GNSS validity duration;
receive a measurement gap configuration associated with GNSS reporting, wherein the measurement gap configuration comprises an indication of time resources for performing GNSS acquisition;
acquire GNSS during the time resources indicated by the measurement gap configuration; and
send a second report via medium access control (MAC) control element (CE), wherein the second report indicates a remainder of the GNSS validity duration.

32. The WTRU of claim 31, wherein the processor is configured to send the first report upon completion of an RRC connection establishment or upon resuming an RRC connection.

33. The WTRU of claim 31, wherein the processor is configured to send the second report during a random access procedure.

34. The WTRU of claim 31, wherein the GNSS validity duration comprises an indication of a time duration associated with a validity of a GNSS acquisition, and the remainder of the GNSS validity duration comprises an indication of a time duration associated with an expiration of the GNSS acquisition.

35. The WTRU of claim 31, wherein the GNSS validity duration indicates an explicit time duration associated with a validity of a GNSS acquisition.

36. The WTRU of claim 35, wherein the remainder of the GNSS validity duration indicates an explicit time duration associated with an expiration of the GNSS acquisition.

37. The WTRU of claim 31, wherein the GNSS acquisition time comprises a time to acquire a GNSS position.

38. The WTRU of claim 31, wherein the processor is configured to perform location-based measurements to acquire the GNSS during the time resources indicated by the measurement gap configuration.

39. The WTRU of claim 31, wherein the processor is configured to determine a GNSS position associated with the WTRU to acquire the GNSS.

40. The WTRU of claim 31, wherein GNSS acquisition is based on capability information associated with the WTRU or a speed of the WTRU.

41. The WTRU of claim 31, wherein the WTRU is an internet of things (IOTs) device.

42. The WTRU of claim 31, wherein the WTRU is a reduced capability (RedCap) device.

43. A method implemented by a wireless transmit receive unit (WTRU), the method comprising:
receiving configuration information for reporting Global Navigation Satellite System (GNSS) assistance information;
after a change in radio resource control (RRC) state of the WTRU, sending a first report comprising GNSS assistance information via RRC signaling, wherein the GNSS assistance information comprises a GNSS acquisition time and a GNSS validity duration;
receiving a measurement gap configuration associated with GNSS reporting, wherein the measurement gap configuration comprises an indication of time resources for performing GNSS acquisition;
acquiring GNSS during the time resources indicated by the measurement gap configuration; and
sending a second report via medium access control (MAC) control element (CE), wherein the second report indicates a remainder of the GNSS validity duration.

44. The method of claim 43, further comprising sending the first report upon completion of an RRC connection establishment or upon resuming an RRC connection.

45. The method of claim 43, further comprising sending the second report during a random access procedure.

46. The method of claim 43, wherein the GNSS validity duration comprises an indication of a time duration associated with a validity of a GNSS acquisition, and the remainder of the GNSS validity duration comprises an indication of a time duration associated with expiration of the GNSS acquisition.

47. The method of claim 43, wherein the GNSS validity duration indicates an explicit time duration associated with a validity of a GNSS acquisition.

48. The method of claim 47, wherein the remainder of the GNSS validity duration indicates an explicit time duration associated with expiration of the GNSS acquisition.

49. The method of claim 43, wherein the GNSS acquisition time comprises a time to acquire a GNSS position.

50. The method of claim 43, further comprising performing location-based measurements to acquire the GNSS during the time resources indicated by the measurement gap configuration.
